(19) United States
(12) Patent Application Publication
(10) Pub. No.: US 2010/0178866 A1
(43) Pub. Date: Jul. 15, 2010

(54) POWER MANAGEMENT OF A NEAR FIELD COMMUNICATION APPARATUS

(75) Inventor: Janne Jalkanen, Espoo (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/516,248

(22) PCT Filed: Nov. 27, 2006
(86) PCT No.: PCT/FI2006/050520

§ 371 Date: Jan. 6, 2010

(51) Int. Cl. H04B 5/00

(52) U.S. Cl. 455/41.1

(57) ABSTRACT

A method for managing power of an apparatus having near field communication capability is described. The apparatus is provided with at least one power saving mode. A near field communication tag reader is used to detect the proximity of a near field communication tag (41). In response to detecting the proximity of the near field communication tag, a conclusion that the apparatus is not in use is made (42, 43). The apparatus is caused to enter said at least one power saving mode in response to making said conclusion (44).

### FIELD OF THE INVENTION

The present invention relates to managing power of a near field communication apparatus.

### BACKGROUND OF THE INVENTION

The term near field communication covers various short-range techniques and technologies which enable wireless communication between devices when they are touched together or brought close together. Accordingly, the term near field communication covers, among other things, various contactless close-to-touch connectivity technologies which involve electromagnetic and/or electrostatic coupling. The term covers the RFID (Radio Frequency IDentification) technology as well as the specific NFC (Near Field Communication) technology specified by following standardization bodies: NFC Forum, International Organization for Standards (ISO) and ECMA International. The operating distance achieved by different near field communication techniques is typically from around 0 cm to around few tens of centimeters. Despite the fact that the acronym NFC has a particular meaning specified by the NFC Forum, in the following description the acronym NFC is used in the place of near field communication in its broadest sense.

Two NFC devices can use magnetic field induction to establish a peer-to-peer network to exchange data. In an active mode, both NFC devices generate their own radio frequency fields to transfer data. In a passive mode, only one of the NFC devices actively generates the radio frequency field. The other (passive) NFC device uses load modulation to transfer data.

Power management is especially important in battery-powered devices. Examples of such devices are different portable handset type of devices, such as NFC enabled handsets. An NFC module hosted by a handset is typically powered by a power source, for example a battery, in the hosting handset. The power consumption of the NFC module therefore affects the total power consumption of the handset leading to shorter standby and talking times in a case where the handset is a mobile phone, for example.

### SUMMARY

According to a first aspect of the invention there is provided a method for managing power of an apparatus, the method comprising:
providing the apparatus with at least one power saving mode;
detecting with a near field communication tag reader the proximity of a near field communication tag;
making a conclusion that the apparatus is not in use, in response to detecting the proximity of the near field communication tag; and
causing the apparatus to enter said at least one power saving mode in response to making said conclusion.

In an embodiment, the apparatus is a portable handset having near field communication capability.

In an embodiment, the tag is attached in a user's clothing or a carrying case of the handset. It is generally separate from the tag reader.

With regard to the conclusion “not in use” it should be noted that in some embodiments, the conclusion “not in use” means that the user does not actively use the apparatus. In these cases, he/she may still use the apparatus passively, for example, listen to music while the apparatus is otherwise placed into his/her pocket or carrying case.

In an embodiment, a dedicated near field communication (or RFID) tag is read, wherein reading the tag triggers entering the reader into said power saving mode. The reader may be in the form of a near field communication module which is integrated into the apparatus or handset. Alternatively, the reader or near field communication module may be inserted or attached otherwise to the apparatus. It may form a separate device which may communicate with the handset or remaining portion of the apparatus using another short-range communication technology, such as Bluetooth. Accordingly, it can be understood the in different embodiments, the reader or near field communication module either forms part of the apparatus, is the apparatus or is separate from the apparatus.

In some embodiments of the invention, either the reader module or the hosting apparatus or both are triggered to enter a power saving mode in response to making the conclusion that the apparatus is not in use. In an embodiment, the near field communication module polling rate is lowered to save power. In another embodiment, the polling feature may be turned off completely. The polling feature can then be turned back on when the user or another trigger mechanism reactivates it.

According to a second aspect of the invention there is provided an apparatus comprising:
a processing unit configured to control at least one power saving mode;
a near field communication tag reader for detecting the proximity of a near field communication tag, wherein
the apparatus is configured to make a conclusion that the apparatus is not in use, in response to detecting the proximity of the near field communication tag, and wherein
the apparatus is configured to enter said at least one power saving mode in response to making said conclusion.

In an embodiment, the apparatus is a handheld mobile phone having cellular network communication capability.

In an embodiment, entering said power saving mode includes entering a mobile phone into a power saving key-lock state. In this state, the backlight of the phone remains unlit unless a correct key combination is entered, thereby saving power.

In an embodiment, the apparatus comprises a display, wherein the apparatus is arranged to turn of the display in response to making the conclusion that the apparatus is not in use.

In another embodiment, the apparatus is a multipart device comprising a main communication module and a tag reader, wherein the tag reader is separate from the main communication module. The tag reader and main communication module may communicate with each other wirelessly, for example, by using WLAN or Bluetooth.

In another embodiment, the apparatus comprises a set of subsystems, such as short-range transceiver subsystems (NFC, WLAN, Bluetooth etc.), and in response to detecting that the apparatus is not actively in use, at least one of these subsystems is commanded to enter power saving mode.

According to a third aspect of the invention there is provided a first near field communication apparatus, comprising:
a near field communication function, wherein
the near field communication function is configured to trigger power saving functionality in a separate second near field communication apparatus.

In an embodiment, the near field communication function of the first near field communication apparatus is configured to trigger power saving functionality in the separate second near field communication apparatus by causing the separate second near field communication apparatus to make a conclusion that the separate second near field communication apparatus is not in use.

In an embodiment, the first near field communication apparatus may be a passive mode near field communication tag, or an active mode near field communication tag. Alternatively, it may be an active mode near field communication apparatus (e.g., a mobile phone or handset), such as the separate second near field communication apparatus can be. The active mode near field communication apparatus may function in a tag emulation mode. This may just be a mode in which the apparatus emulates an active mode tag.

In an embodiment, said first near field communication apparatus (such as a tag) comprises specifically formatted data to trigger power saving functionality in an external device. In an embodiment, this specifically formatted data comprises a set of instructions implemented by software, hardware or suitable combination of software and hardware or other suitable manner, wherein when said separate second near field communication apparatus (e.g., a reader or another mobile apparatus) reads these instructions, the instructions cause (or force) the reader or apparatus to make an association that the apparatus is not in use. In response to this conclusion, the reader and/or apparatus enters a power saving mode. The instructions may define a particular power saving mode and force the reader and/or apparatus to enter that power saving mode.

According to a fourth aspect of the invention there is provided a near field communication module, comprising:
control means for controlling at least one power saving mode;
reader means for detecting the proximity of a near field communication tag, wherein
said control means are configured to make, in response to detecting the proximity of the near field communication tag, a conclusion that an apparatus in which the near field communication module resides, or is coupled to, is not in use, and wherein
said control means are configured to cause the near field communication module to enter said at least one power saving mode in response to making said conclusion.

According to a fifth aspect of the invention there is provided a computer program stored in a computer readable medium, the computer program comprising computer executable program code (or software) adapted to cause an apparatus to perform the method of the first aspect.

In some embodiments, the term “not in use” means that the user does not actively use the apparatus, but the apparatus can otherwise be in operation and the user can passively use the apparatus.

Various embodiments of the present invention are illustrated only with reference to certain aspects of the invention. It should be appreciated that corresponding embodiments may apply to other aspects as well.

### BRIEF DESCRIPTION OF THE DRAWINGS

The invention will be described, by way of example only, with reference to the accompanying drawings, in which:

FIG. 1 shows an NFC enabled device in accordance with an embodiment of the invention;

FIG. 2 shows an NFC module in accordance with an embodiment of the invention;

FIG. 3 shows an NFC tag in accordance with an embodiment of the invention;

FIG. 4 shows a flow chart illustrating an embodiment of the invention; and

FIG. 5 shows another embodiment of the invention.

### DETAILED SPECIFICATION

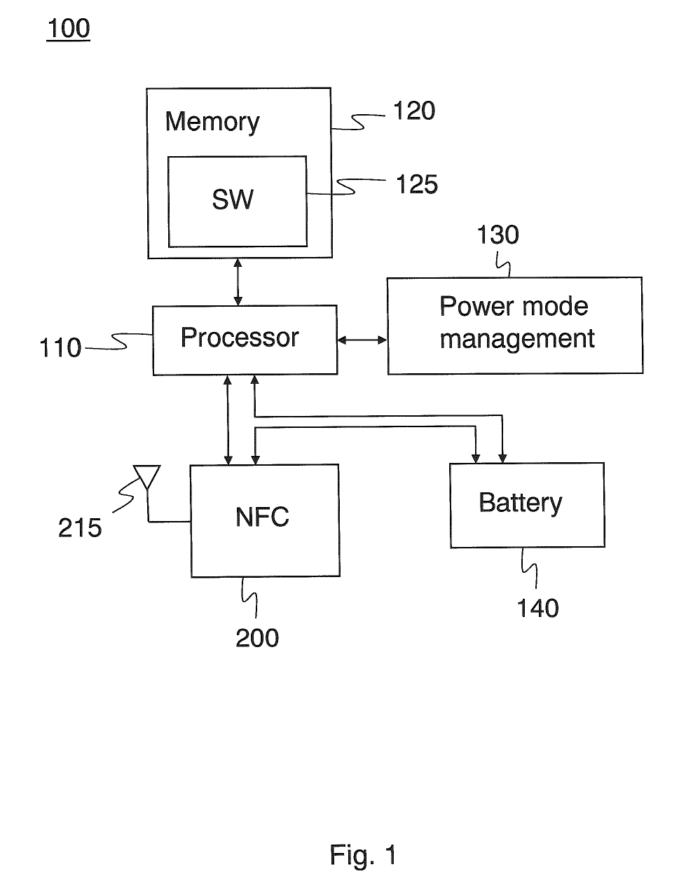

FIG. 1 shows a near field communication enabled device 100 in accordance with an embodiment of the invention. The device 100 comprises a processor 110 for controlling the device 100, a memory 120 coupled to the processor 110 and computer program code or software 125, which is stored into memory 120. The software 125 may include instructions for processor 110 to control the operation of the device 100.

The device 100 comprises a NFC module 200 which is coupled to the processor 110. The NFC module 200 comprises an antenna 215 for generating a short-range radio frequency field.

The device 100 further comprises a power mode management function 130 and a battery 140. The device 100 and the NFC module 200 are powered by the battery 140. The power mode management function 130 makes power saving decisions for the device 100.

In case the device 100 is a mobile phone, it further comprises a cellular network transceiver (not shown). It may further comprise a keyboard and a display and other features that a mobile station typically comprises. In another embodiment, the device 100 is any device which comprises a display, for example, a personal digital assistant, a blackberry device, a navigator, a music player or mp3 player or similar.

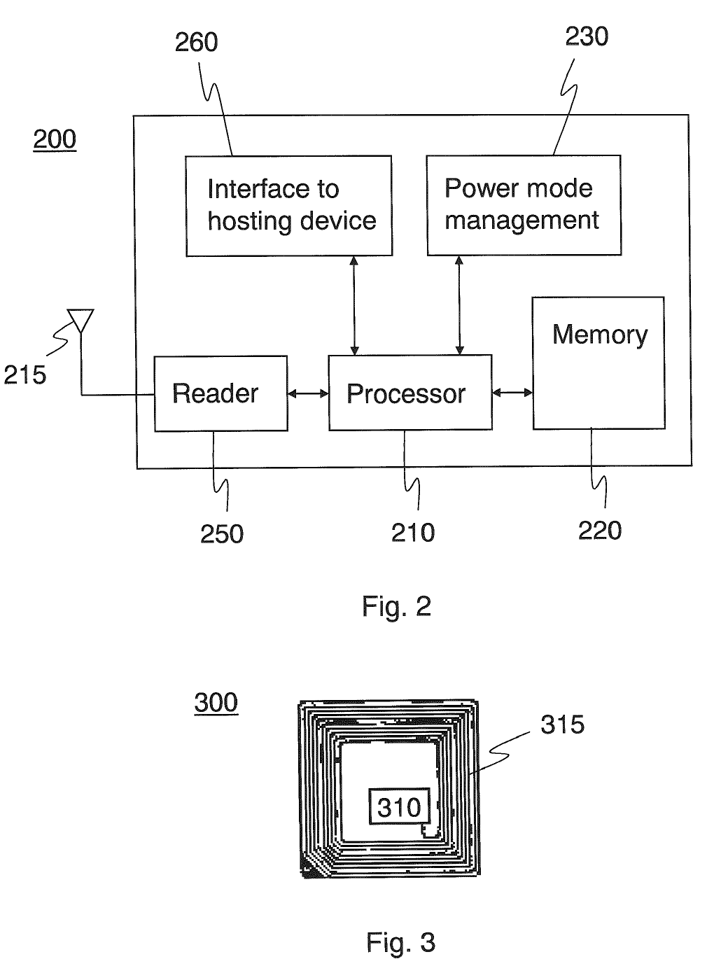

FIG. 2 shows the NFC module 200 in accordance with an embodiment of the invention. It may be an RFID module. It is able to read NFC or RFID tags over a read distance, typically from 0 cm to around 20 cm or more.

The NFC module 200 comprises a processor 210 for controlling the NFC module 200, a memory 220 coupled to the processor 210 and a reader portion 250 coupled to the antenna 215 for generating the short-range radio frequency field.

The NFC module further comprises a power mode management function 230 and an interface 260 for communicating with parts of the hosting device 100. The power mode management function 230 makes power saving decisions for the NFC module 200.

FIG. 3 shows an example of an NFC tag 300. It may be an RFID tag. The tag 300 generally comprises a spiral formed antenna 315 and a processing chip 310 coupled with the antenna. In an embodiment, the tag 300 operates in a passive mode. However, it is also possible to use tags in an active mode. One example on an active mode tag is any NFC enabled handset or device which operates in a tag emulation mode. In this mode the NFC enabled handset or device emulates an active mode NFC tag.

Generally, NFC or RFID tags may be active, containing their own RF transmitter, or passive, having no transmitter. Passive tags, that is, tags that rely upon modulated back-scattering to provide a return link to an interrogating base station, may include their own power sources, such as a batteries, or they may be “field-powered”, whereby they obtain their operating power by rectifying an interrogating RF signal that is transmitted by a base station. Although both battery-powered and field powered tags have minimum RF field strength read requirements, or read thresholds, in general, a field-powered passive system requires at least an order of magnitude more power in the interrogating signal than a system that employs tags having their own power sources. Because the interrogating signal must provide power to a field-powered passive tag, the read threshold for a field-powered passive tag is typically substantially higher than for an active tag. However, because field-powered passive tags do not include their own power source, they may be substantially less expensive than active tags and because they have no battery to “run down”, field-powered passive tags may be more reliable in the long term than active tags. And, finally, because they do not include a battery, field-powered passive tags are typically much more “environmentally-friendly”.

In an embodiment, the tag 300 is a dedicated tag which is placed or integrated into a user's clothing (e.g., sleeve or pocket) or into a physical object, such as a carrying case or similar. When the NFC device 100 (e.g., a mobile phone) is put into a pocket, sleeve, carrying case or the like, the tag 300 comes within the read distance of the NFC module 200. The reader portion 250 controlled by the processor 210 reads the tag 300. Information about the dedicated tag 300 and power management modes has been beforehand stored into memory 220. The power mode management function 230 retrieves this information from memory 220. If the read dedicated tag information corresponds to the stored one, the power mode management function 230 makes the conclusion that the device 100 is not in use. In response to making this conclusion, the power mode management function 230 sets the NFC module 200 into a pre-defined power saving mode.

In NFC technology, a polling feature is defined. Polling is a function during which the reader creates an electric field to check if any tags or other NFC devices are present. Polling comprises two alternate phases: a power consuming polling phase when the device actually polls by transmitting interrogation signals, and a listening phase when the device is merely listening. The power consumption during the polling phase is far more than that during the listening phase. Typical values of the polling phase and the listening phase are 20 ms and 200-300 ms, respectively. In an embodiment, a dedicated tag 300 is used to control the polling feature to save power. In this embodiment, the power saving mode comprises operating in a lowered NFC polling rate, thereby saving power. In practice, a power saving mode can be defined in which the time between polls, that is, the listening phase is set longer. The listening phase can be set for example to 5 seconds.

In the above embodiment, power can be saved in situations where the user is not typically using his device 100. This means that whenever the device 100 is unused (e.g., a phone in a pocket, carrying bag or a purse), it will consume less power because in those situations it is made poll more infrequently. Whenever the device 100 is removed from the pocket or the like and the tag 300 gets beyond the read distance of the NFC module 200 and the NFC module detects that the tag 300 is no longer present, the power mode management function 230 will again cause the device to poll at a normal rate (starting from the next poll cycle).

The dedicated tag 300 can be implemented by defining and using a single NDEF type (for example, “nfc:ext:nokia.com:Sleep”) which has empty contents. When the NFC module 200 sees this tag, it will make the conclusion that the device is not in use and enter power saving mode. If this tag is not seen by the NFC module 200, normal mode is resumed.

In another embodiment, the NFC device 100 hosting the NFC module 200 or the like is caused to enter a power saving mode in response to making the conclusion that the device is not in use. This may occur independently of whether the NFC module 200 enters a power saving mode. In this embodiment, when the tag 300 comes within the read distance of the NFC module 200, the reader portion 250 controlled by the processor 210 again reads the tag 300. If the power mode management function 230 subsequently makes the conclusion that the device 100 is not in use, this information is sent via the interface 260 to the hosting device 100. The power mode management function 130 of the hosting device will then make a decision to enter the hosting device 100 into a power saving mode that has been pre-defined in the software 125 of the device memory 120. If the device 100 is for example a mobile phone, the power saving mode may include for example setting the device into a power saving key-lock state. If the device 100 is any other device having a display, the power saving mode may comprise turning off the display upon detecting that the device is not in use. For example, when a mobile phone is in a person's pocket, the display does not typically have to be on. In some embodiments, the conclusion “not in use” does not mean that the device 100 is completely unusable. For example, when the user puts his/her mobile phone, which has a built-in FM radio receiver, into a pocket or carrying case, the FM radio receiver may still be in operation and send signals to user's handsfree device at his/her ear. In this case, it is also desirable to enter power saving display by, e.g., shutting down the display. In this case, the conclusion “not in use” means that the user does not actively use the phone, but only passively.

In yet another embodiment, the device 100 is an accessory device, such as a displayless device, for example, a headset (Bluetooth headset or similar). The headset comprises the NFC module which is able to read tags. When the tag comes within the read distance of the NFC module (e.g., the headset is put into a pocket or the like) a power mode management module of the headset concludes that the headset is not in use. In response the headset enters a power saving mode or is automatically switched off.

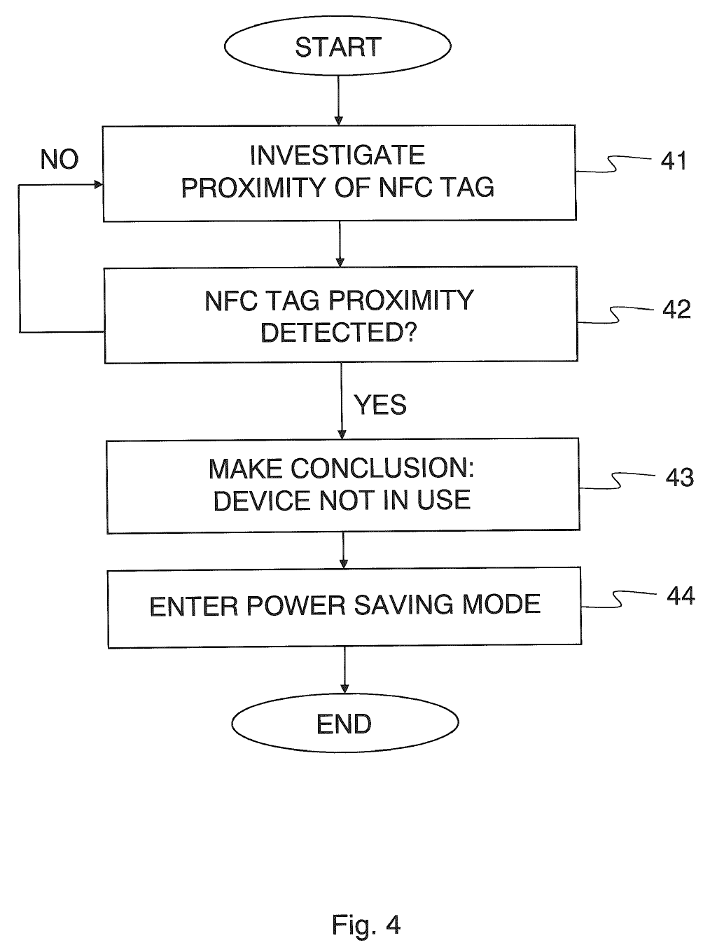

FIG. 4 shows a flow chart illustrating an embodiment of the invention. In step 41 it is investigated at a normal polling rate whether a dedicated NFC tag is in proximity. If the proximity of the tag is not detected step 41 is resumed via step 42. If the proximity of the tag is detected step 43 is entered via step 42. In step 43 a conclusion is made that the device is not in use, since it is so close to the dedicated tag. Based on this conclusion power saving mode is entered in step 44.

After the device has entered the power saving mode the proximity of the tag is investigated at a lowered near field communication polling rate. When the proximity of the tag is no longer detected, the device in response returns to normal operation mode (normal polling rate).

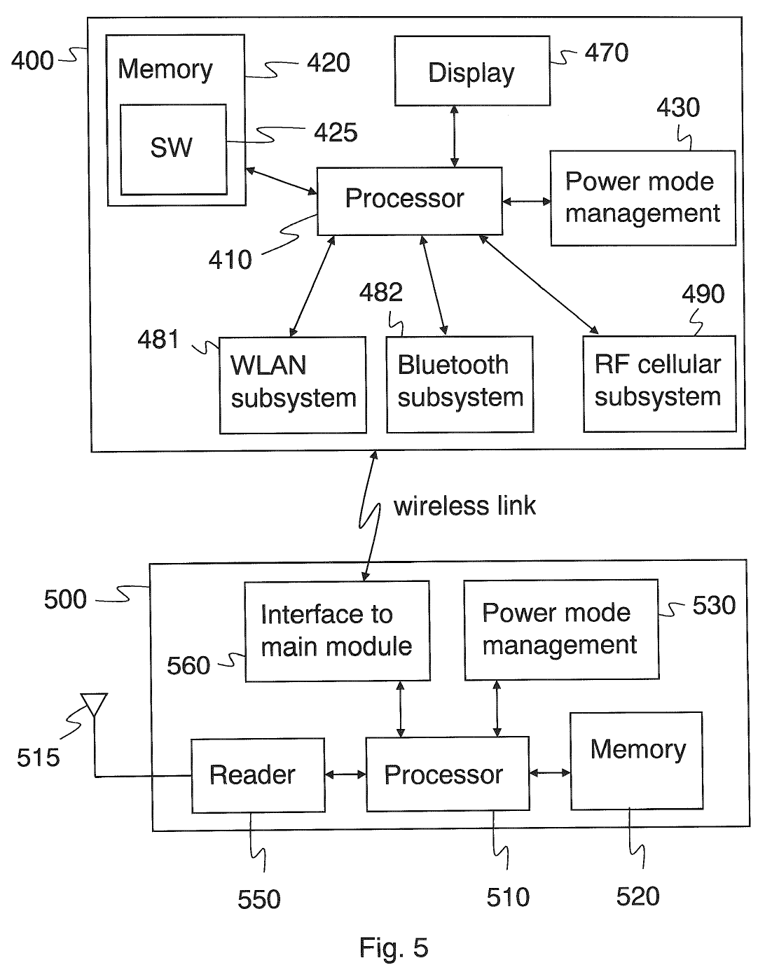

FIG. 5 shows an apparatus in accordance with yet another embodiment of the invention. The apparatus is formed as a multipart device comprising a main communication module 400 and a separate independent reader module 500. The main module 400 comprises a processor 410 for controlling the main module 100, a memory 420 coupled to the processor 410 and computer program code or software 425, which is stored into memory 420. The software 425 may include instructions for processor 410 to control the operation of the main module 400.

The main module 400 comprises a set of subsystems. These may include a display 470, a set of transceiver subsystems, such as WLAN subsystem 481, Bluetooth subsystem 482 and a cellular network subsystem 490, coupled to the processor 410.

The main module 400 further comprises a power mode management function 430. The power mode management function 430 makes power saving decisions for the apparatus.

The reader module 500 comprises a processor 510 for controlling the reader module 500, a memory 520 coupled to the processor 510 and a near field communication reader portion 550 coupled to an antenna 515 for generating a short-range radio frequency field in order to detect the proximity of the near field communication tag 300 (not shown in FIG. 5).

The reader module 500 further comprises a power mode management function 530 and an interface 560 for communicating with the main module 400 by using a wireless link. The power mode management function 530 makes power saving decisions for the reader module 500. Depending on the implementation, the power mode management function(s) may be implemented either in the main module 400, reader module 500, or both. Wireless communication between the main module 400 and the reader module may be implemented by a suitable short-range technology, such as Bluetooth or WLAN or similar.

When the reader module 500 discovers the proximity of the tag 300, in an embodiment, it sends information about this to the main module via the interface 560. The interface 560 may comprise a short-range radio frequency transceiver, such as a Bluetooth or WLAN transceiver. The main module 400 receives this information, for example, via the Bluetooth or WLAN subsystems 482, 481. The power mode management function 430 makes the conclusion that the main module is not in use (at least not actively in use), and commands the main module 400 to enter a power saving mode. In practice, this may mean that one or more of the subsystems (that is, display 470 and transceiver subsystems 481, 482 and 490) are caused to enter a power saving mode. In an embodiment, the power mode management function 430 may send a request to the reader module 500 to enter power saving mode. In another embodiment, the power saving modes of the reader module 500 are handled by the reader's power mode management function 530 alone.

Various embodiments of the invention have been presented. It should be appreciated that in this document, words comprise, include and contain are each used as open-ended expressions with no intended exclusivity.

The foregoing description has provided by way of non-limiting examples of particular implementations and embodiments of the invention a full and informative description of the best method and apparatus presently contemplated by the inventors for carrying out the invention. It is however clear to a person skilled in the art that the invention is not restricted to details of the embodiments presented above, but that it can be implemented in other embodiments using equivalent means without deviating from the characteristics of the invention.

Furthermore, some of the features of the above-disclosed embodiments of this invention could be used to advantage without the corresponding use of other features. As such, the foregoing description should be considered as merely illustrative of the principles of the present invention, and not in limitation thereof. Hence, the scope of the invention is only restricted by the appended patent claims.

1. A method comprising:
detecting with a near field communication tag reader the proximity of a near field communication tag;
making a conclusion that the an apparatus is not in use, in response to detecting the proximity of the near field communication tag; and
causing the apparatus to enter said at least one power saving mode in response to making said conclusion.

2. A method according to claim 1, wherein causing the apparatus to enter said power saving mode comprises causing a near field communication module, comprised by said apparatus, to lower a near field communication polling frequency.

3. The method according to claim 1, wherein causing the apparatus to enter said power saving mode comprises causing the apparatus to enter a key-lock state.

4-21. (canceled)

22. A method according to claim 1, wherein the apparatus comprises a display and wherein causing the apparatus to enter said power saving mode comprises turning off the display.

23. A method according to claim 1, wherein the apparatus is a portable handset.

24. A method according to claim 1, wherein the apparatus is a multipart device comprising a main communication module and said near field communication tag reader which is separate from said main communication module, and wherein the main communication module and the separate near field communication tag reader are configured to communicate with each other wirelessly.

25. An apparatus comprising:
a processing unit configured to control at least one power saving mode;
a near field communication tag reader configured to detect the proximity of a near field communication tag, wherein
the apparatus is configured to make a conclusion that the apparatus is not in use, in response to detecting the proximity of the near field communication tag, and wherein
the apparatus is configured to enter said at least one power saving mode in response to making said conclusion.

26. The apparatus of claim 7, wherein entering said at least one power saving mode comprises causing a near field communication module, comprised by said apparatus, to lower a near field communication polling frequency.

27. The apparatus of claim 7, wherein entering said at least one power saving mode comprises causing the apparatus to enter a key-lock state.

28. The apparatus of claim 7, wherein said apparatus is a near field communication module configured to be hosted by a hosting device.

29. The apparatus of claim 7, wherein said apparatus is a portable handheld device having a set of subsystems, and wherein entering said at least one power saving mode comprises entering at least one subsystem into a power saving mode.

30. The apparatus of claim 11, wherein the set of subsystems comprises a display, and wherein entering said at least one power saving mode comprises turning off the display.

31. The apparatus of claim 7, comprising a portable handset.

32. The apparatus of claim 13, wherein the portable handset is a mobile phone.

33. The apparatus of claim 7, wherein the apparatus is a multipart device comprising a first part and a second part wirelessly coupled with each other.

34. A computer program product comprising computer executable program code stored in a computer readable medium, comprising:
code for providing an apparatus with at least one power saving mode;
code for detecting with a near field communication tag reader the proximity of a near field communication tag;
code for making a conclusion that the apparatus is not in use, in response to detecting the proximity of the near field communication tag; and
code for causing the apparatus to enter said at least one power saving mode in response to making said conclusion.

35. A computer program product according to claim 16, wherein the code for causing the apparatus to enter said at least one power saving mode comprises a code for causing a near field communication module, comprised by said apparatus, to lower a near field communication polling frequency.

36. A computer program product according to claim 16, wherein the code for causing the apparatus to enter said at least one power saving mode comprises a code for causing the apparatus to enter a key-lock state.

37. A computer program product according to claim 16, wherein the code for causing the apparatus to enter said at least one power saving mode comprises a code for turning off a display of the apparatus.
